(19) United States
(12) Patent Application Publication
(10) Pub. No.: US 2004/0187086 A1
(43) Pub. Date: Sep. 23, 2004

(54) Single edge-triggered flip-flop design with asynchronous programmable reset

(76) Inventors: Pradeep R. Trivedi, Sunnyvale, CA (US); Gin S. Yee, Sunnyvale, CA (US); Joseph R. Siegel, Shrewsbury, MA (US)

Correspondence Address: ROSENTHAL & OSHA L.L.P., Suite 2800, 1221 McKinney Street, Houston, TX, 77010, US

(21) Appl. No.: 10/390,314

(22) Filed: Mar. 17, 2003

(51) Int. Cl. G06F 17/50

(52) U.S. Cl. 716/6

(57) ABSTRACT

A single edge-triggered flip-flop having an asynchronous programmable reset function is provided. Using an externally generated reset value, the single edge-triggered flip-flop may be asynchronously programmed to dynamically reset to either a logical high or a logical low. Further, a single edge-triggered flip-flop having a reduced hold time is provided. In particular, by inputting a clock signal into a slave stage of the single edge-triggered flip-flop before inputting the clock signal into a master stage of the single edge-triggered flip-flop, the single edge-triggered flip-flop's hold time may be reduced without negatively increasing a setup time of the single edge-triggered flip-flop.

### BACKGROUND OF INVENTION

A typical computer system includes at least a microprocessor and some form of memory. The microprocessor has, among other components, arithmetic, logic, and control stages that interpret and execute instructions necessary for the operation and use of the computer system. FIG. 1 shows a typical computer system (10) having a microprocessor (12), memory (14), integrated circuits (16) that have various functionalities, and communication paths (18), i.e., buses and wires, that are necessary for the transfer of data among the aforementioned components of the computer system (10).

The various computations and operations performed by the computer system arc facilitated through the use of signals that provide electrical pathways for data to propagate between the various components of the computer system. In a general sense, the passing of data onto a signal may be accomplished by changing, i.e., transitioning, the logical value, i.e., the logical state, of the signal. Specifically, the logical state of a signal may be transitioned by either raising the voltage of the signal or reducing the voltage of the signal. When the voltage is raised, the signal is said to be at a “logic high,” and when the voltage is reduced, the signal is said to be at a “logic low.”

An integrated circuit, such as ones shown in FIG. 1, includes various types of elementary logic components that are used to store, transfer, and/or manipulate the logical values of signals. One example of an elementary logic component is a flip-flop. In general, a flip-flop is a state element, i.e., a device that stores the logical state of a signal, capable of outputting a stored signal state depending on a logical transition of a clock signal at an input of the flip-flop. In many cases, flip-flops in integrated circuits are single edge-triggered. Single edge-triggered flip-flops store, i.e., latch, state either on a positive edge (a ‘low’ to ‘high’ transition) of a clock signal or on a negative edge (a ‘high’ to ‘low’ transition) of the clock signal.

FIG. 2a shows a typical single edge-triggered flip-flop (19). As shown in FIG. 2a, the single edge-triggered flip-flop (19) has a data input d, a data output q, and a clock signal input ck. The single edge-triggered flip-flop (19) is designed such that a value at the data input d is transferred to the data output q on a positive (or a negative) edge of a clock signal clk inputted at the clock signal input ck.

FIG. 2b shows a circuit diagram of the single edge-triggered flip-flop (19) shown in FIG. 2a. As shown, the single edge-triggered flip-flop (19) includes a latch (20) formed by a pair of cross-coupled inverters. A first pass gate (22) (typically formed by a P-channel transistor coupled to an N-channel transistor) and a second pass gate (24) are coupled at terminals of the first latch (20). The first pass gate (22) and the second pass gate (24) respectively receive complemented and non-complemented versions of the clk signal. Accordingly, on a positive edge of the clock clk signal, the data stored by the latch (20) is sent to data output q.

Note that, in an alternative embodiment, the first pass gate (22) and the second pass gate may respectively receive non-complemented and complemented versions of the clk signal. In this alternative embodiment, the data stored by the latch (20) is sent to data output q on the negative edge of the elk signal.

### SUMMARY OF INVENTION

According to one aspect of the present invention, an integrated circuit comprises a control stage arranged to receive a clock signal, a reset signal, and a reset value signal; a master stage operatively connected to the control stage and arranged to receive a data signal and the reset signal, wherein the master stage is arranged to generate an output value dependent on the control stage and the data signal; and a slave stage operatively connected to the control stage and the master stage and arranged to receive the clock signal and the output value, wherein the slave stage is arranged to generate an output signal dependent on the clock signal and the output value, wherein, upon assertion of the reset signal, the output signal is set to a value of the reset value signal asynchronous of the clock signal and dependent on the control stage.

According to another aspect of the present invention, a single edge-triggered flip-flop capable of being programmably reset asynchronous of a clock signal comprises control means for receiving the clock signal and a reset signal; master means for generating an output value dependent on the control means and a data signal; slave means for generating an output signal dependent on the control means and the output value, wherein, upon assertion of the reset signal, the output signal is set to a programmed value asynchronous of the clock signal and dependent on the control means.

According to another aspect of the present invention, a method for performing a single edge-triggered flip-flop operation comprises inputting a data signal, a reset signal, and a reset value signal; latching an output value on an edge of a clock signal dependent on the data signal; generating an output signal dependent on the clock signal and the output value; and upon assertion of the reset signal, setting the output signal to a value of the reset value signal asynchronous of the clock signal.

Other aspects and advantages of the invention will be apparent from the following description and the appended claims.

### BRIEF DESCRIPTION OF DRAWINGS

FIG. 1 shows a typical computer system.

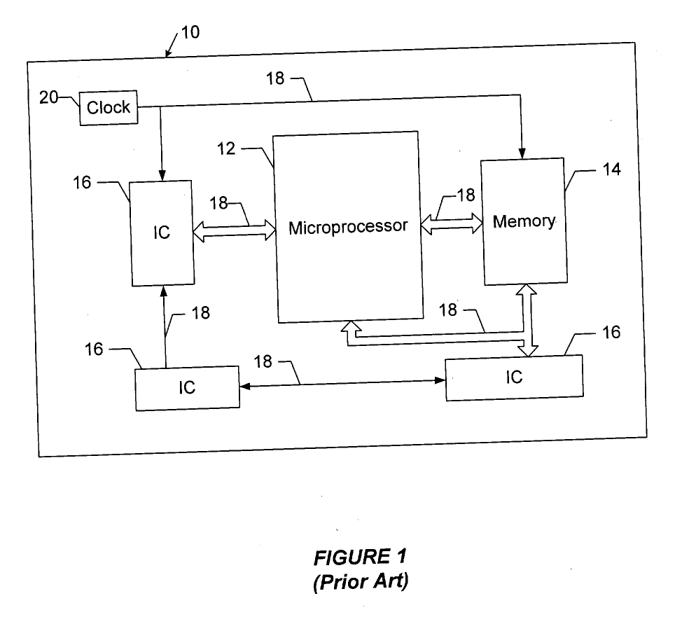

FIG. 2a shows a block diagram of a typical single edge-triggered flip-flop.

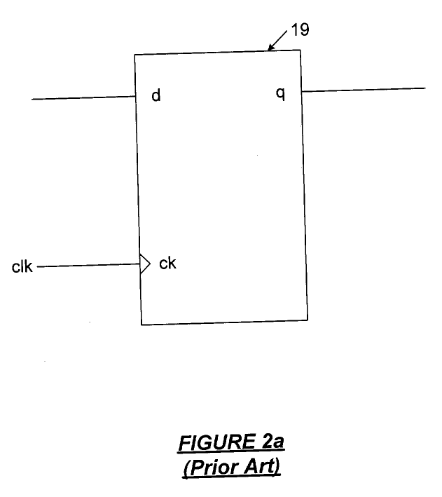

FIG. 2b shows a circuit schematic of the single edge-triggered flip-flop shown in FIG. 2a.

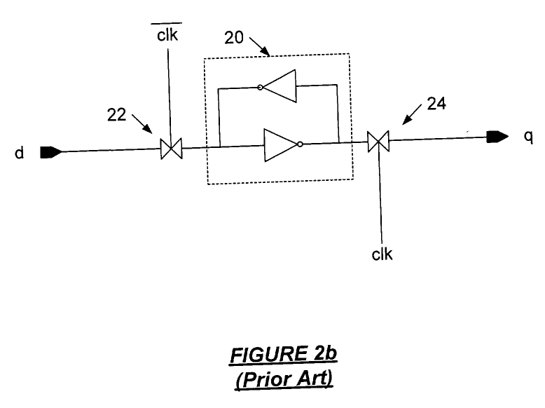

FIG. 3 shows a circuit schematic of a single edge-triggered flip-flop in accordance with an embodiment of the present invention.

FIG. 4 shows simulation waveforms in accordance with the embodiment shown in FIG. 3.

### DETAILED DESCRIPTION

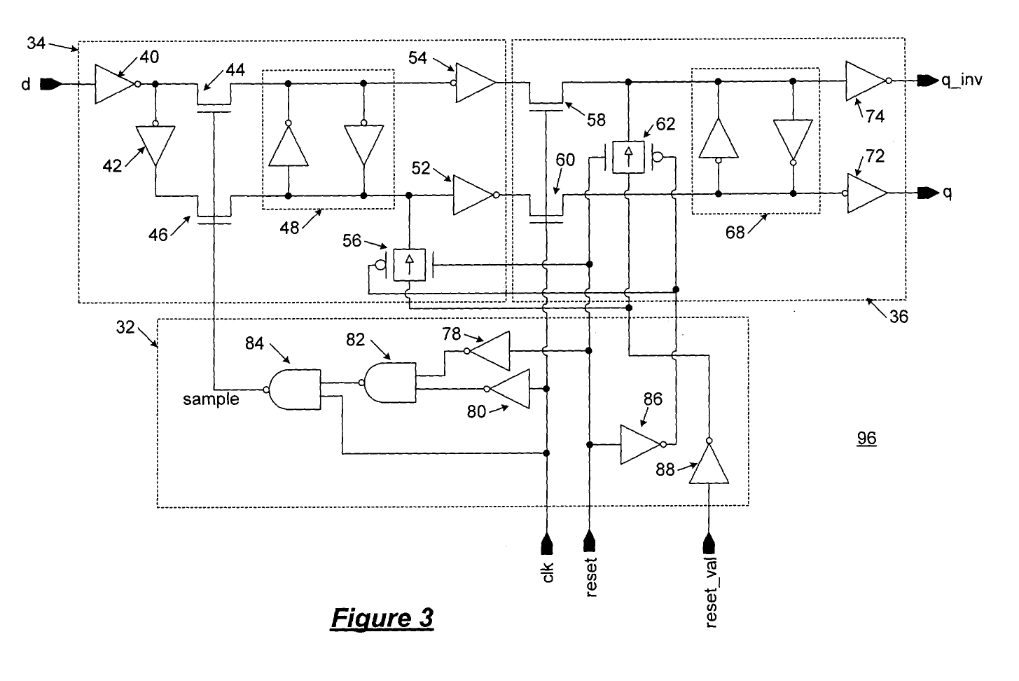

Embodiments of the present invention will be described with reference to the accompanying drawings. Embodiments of the present invention relate to a single edge-triggered flip-flop that may be programmably reset independent of a clock signal. FIG. 3 shows an exemplary circuit-level schematic of a single edge-triggered flip-flop (96) in accordance with an embodiment of the present invention. In the embodiment shown in FIG. 3, the single edge-triggered flip-flop (96) includes a master stage (34), a slave stage (36), and a control stage (32).

The control stage (32) may be used to programmably reset the master and slave stages (34, 36) independent of a clock signal.

In addition to the above-mentioned circuitry, the single edge-triggered flip-flop (96) includes the following inputs and outputs: a data input d, a clock input clk, reset inputs reset_val and reset, a data output q, and q's complement q_inv.

The data input d serves as an input to the master stage (34); the input clk serves as an input to the control and slave stages (32, 36); the input reset_val serves as an input to the control stage (32); the input reset serves as an input to the master, the slave, and the control stages (34, 36, 32); and the outputs q and q_inv are outputs of the slave stage (36), and, in turn, serve as the outputs of the single edge-triggered flip flop (96).

Note that, unless otherwise stated, the following description of FIG. 3 assumes that the value of the reset signal is ‘low,’ i.e., the single edge-triggered flip-flop (96) is not being reset. The master stage (34) includes the following circuitry: a first inverter (40), a second inverter (42), a first transistor (44), a second transistor (46), a master latch (48) formed by a pair of cross-coupled inverters, a first pass gate (56), a third inverter (54), and a fourth inverter (52). The first inverter (40) inputs the d signal and outputs d's complement, referred to herein as d_inv, to the second inverter (42) and to a terminal of the first transistor (44). The second inverter (46) inverts d_inv and, thus, outputs d to a terminal of the second transistor (46). Both the first transistor (44) and the second transistor (46) input a sample signal (whose derivation is described below) to their respective gate terminals.

When the sample signal is ‘high,’ the first and second transistors (44, 46) turn ‘on’ and respectively output d and d_inv to the master latch (48). Specifically, the first transistor (44) outputs d_inv to a first terminal of the master latch (48), and the second transistor (46) outputs d to a second terminal of the master latch (48). Further, d_inv on the first terminal of the master latch (48) serves as an input to the third inverter (54), and d on the second terminal of the master latch (48) serves as an input to the fourth inverter (52). In addition, an output terminal of the first pass gate (56) is connected to the input of the fourth inverter (52). The first pass gate (56) inputs a complement of the reset_val signal and is controlled by complemented and non-complemented versions of the reset signal. When reset is ‘high,’ the first pass gate (56) turns ‘on’ and outputs the complement of reset_val to the fourth inverter (52). Thus, reset_val may be used to reset the input of the fourth inverter (52) to a logical high or low.

Note that, because reset_val determines the reset value of the single edge-triggered flip-flop (96), the outputs q and q_inv may be reset to a high value or to a low value. Further, because the reset_val signal is externally generated and inputted to the single edge-triggered flip-flop (96), the reset value of reset_val may be decided upon after the single edge-triggered flip-flop (96) has been fabricated, i.e., manufactured.

In addition, those skilled in the art will appreciate that, dependent on particular design goals and/or requirements, the circuitry and/or signals used to implement the reset function of the dual edge-triggered flip-flip (96) may be configured differently from the manner shown in FIG. 3 without departing from the scope of the present invention.

Referring to FIG. 3, the slave stage (36) includes the following circuitry:

a third transistor (58), a fourth transistor (60), a second pass gate (62), a slave latch (68) formed by a pair of cross-coupled inverters, a fifth inverter (74), and a sixth inverter (72). The third transistor (58) inputs d from the third inverter (54), and the fourth transistor (60) inputs d_inv from the fourth inverter (52). Both the third transistor (58) and the fourth transistor (60) input the clk signal to their respective gate terminals. Thus, when clk is ‘high,’ the third and fourth transistors (58, 60) turn ‘on’ and respectively output d and d_inv to the slave latch (68). Specifically, the third transistor (58) outputs d to a first terminal of the slave latch (68), and the fourth transistor (60) outputs d_inv to a second terminal of the slave latch (68).

Further, d on the first terminal of the slave latch (68) serves as an input to the fifth inverter (74), and d_inv on the second terminal of the slave latch (68) serves as input to the sixth inverter (52). The fifth and sixth inverters (72, 74) output d and d_inv respectively as the output signals q and q_inv for the single edge-triggered flip-flop (96). As shown, the fifth inverter (72) outputs q, and the sixth inverter (74) outputs q_inv.

In addition, the output terminal of the second pass gate (62) is connected to the first terminal of the slave latch (68). The second pass gate (62) inputs the complement of reset_val signal and is controlled by complemented and non-complemented versions of the reset signal. When reset is ‘high,’ the second pass gate (62) turns ‘on,’ and the complement of reset_val is inputted to the first terminal of the slave latch (68). Thus, reset_val may be used to reset the value of d input by the slave latch (68) to a logical high or low.

Referring to FIG. 3, the control stage (32) includes the following circuitry: a first inverter (80), a second inverter (78), a third inverter (86), a fourth inverter (88), a first NAND gate (82), and a second NAND gate (84). The fourth inverter (88) is used to generate the complement of the reset_val signal. Thus, the fourth inverter (88) inputs the reset_val signal and outputs the reset_val complement to the first and second pass gates (56, 62).

Referring again to FIG. 3, the second and third inverters (78, 86) are used to generate the complement of the reset signal. The third inverter (86) inputs the reset signal and outputs the reset complement to the first and second pass gates (56, 62), and the second inverter (78) inputs the reset signal and outputs the reset complement to the first NAND gate (82). The fourth inverter (80) is used to generate the complement of the clk signal. Thus, the fourth inverter (80) inputs the clk signal and outputs the clk complement to the first NAND gate (82). Using the reset complement and the clk complement, the first NAND gate (82) generates an input signal of the second NAND gate (82).

Using the clk signal and the input signal generated by the first NAND gate (82), the second NAND gate (84) generates the sample signal. The sample signal is inputted to the master stage's (34) first and second transistors (44, 46). Thus, whenever reset is ‘low’ and clk is ‘high,’ sample is ‘low,’ i.e., the master stage's (34) first and second transistors (44, 46) are ‘off.’ Otherwise, sample is ‘high,’ i.e., the master stage's (34) first and second transistors (44, 46) are ‘on.’

Note that, because the slave stage (36) inputs clk before the control stage (32) generates the sample signal, sample is inputted to master stage (34) after clk is inputted to the slave stage (36). As a result, a hold time, i.e., a time delay for q to become stable, may be decreased without negatively increasing a setup time, i.e., a time delay for d to become stable, of the single edge-triggered flip-flop (96).

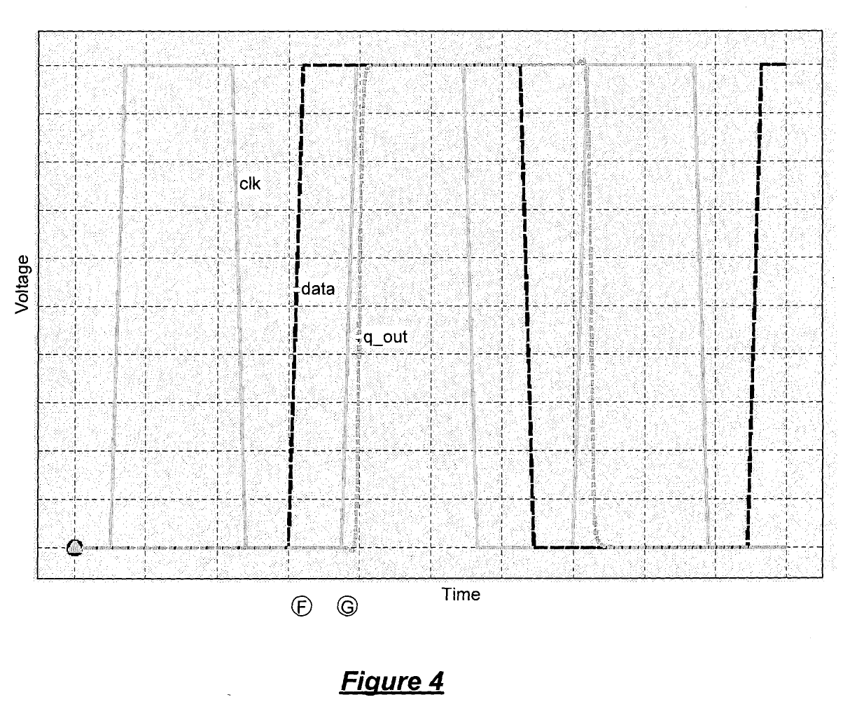

FIG. 4 shows exemplary simulation waveforms in accordance with the embodiment shown in FIG. 3. In FIG. 4, the logical values of the signals clk, d, and q are shown as seen by the single edge-triggered flip-flop (96) during a particular time interval. Note that, although not shown in FIG. 4, the value of the reset signal is set to ‘low.’

In FIG. 4, points “F” and “G” represent different points in time during the time interval in which the waveforms are recorded. Referring to FIG. 4, just before point “F,” the signal values of d, q, and clk are ‘low.’ Thus, the slave stage's (36) third and fourth transistors (58, 60) are ‘off,’ i.e., no new values can be loaded into the slave latch (68), and the master stage's (34) first and second transistors (44, 46) are ‘on,’ i.e., new values can be loaded into the master latch (48). As a result, the master latch (48) inputs the current value of d, a ‘low.’ However, because no new values can be loaded into the slave latch (68), the slave latch (68) continues to hold the most recently stored value for q. At point “F,” d transitions from ‘low’ to ‘high,’ i.e., a positive edge transition. As a result, the signal value inputted by the master latch (48) switches to a ‘high.’ However, because new values still cannot be loaded into the slave latch (68), the slave latch (68) continues to hold the most recently stored value for q, a ‘low.’

At point “G,” clk transitions from ‘low’ to ‘high,’ i.e., a positive edge transition. As a result, sample transitions to ‘low.’ Thus, the third and fourth transistors (58, 60) turn ‘on,’ i.e., new values can now be loaded into the slave latch (68), and the first and second transistors (92, 90) turn ‘off,’ i.e., no new values can be loaded into the master latch (48). As a result, the slave latch (68) loads the most recently stored value of d from the master latch (48), a ‘high,’ and outputs this value as q, a ‘high.’ Thus, at the positive edge transition of clk, the value of q transitions from ‘low’ to high.

Note that, although the waveforms described in FIG. 4 show FIG. 3's single edge-triggered flip-flop (96) embodiment to be positive edge-triggered, a negative-edge triggered version of the single edge-triggered flip-flop (96) could be derived from the embodiment shown in FIG. 3 without departing from the scope of the present invention. Specifically, the single edge-triggered flip-flop (96) may be converted into a negative-edge triggered version by removing the control stage's (32) second NAND gate (84) and by connecting the output of the first NAND gate (84) directly to the first and second transistor's (44, 46) gate terminals. Alternatively, the single edge-triggered flip-flop (96) may be converted into a negative-edge triggered version by inserting an inverter between the output of the second NAND gate (84) and the inputs of the first and second transistor's (44, 46) gate terminals. Those skilled in the art will understand that the single edge-triggered flip-flop may be modified in a number of other ways to achieve negative edge-triggered functionality.

Advantages of the present invention may include one or more of the following. In one or more embodiments, because an externally generated reset value is used to reset a single edge-triggered flip-flop, a reset state for the single edge-triggered flip-flop may be determined after the single edge-triggered flip-flop has been fabricated.

In one or more embodiments, because a slave stage of a single edge-triggered flip-flop inputs a clock signal before a master stage of the single edge-triggered flip-flop inputs the clock signal, a hold time for an output of the single edge-triggered flip-flop may be reduced without negatively increasing a setup time for a data input of the single edge-triggered flip-flop.

In one or more embodiments, the single edge-triggered flip-flop may be asynchronously programmed to dynamically reset to either a logical high or a logical low. Thus, the single edge-triggered flip-flop may be used in multiple types of computing environments.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An integrated circuit, comprising:
a control stage arranged to receive a clock signal, a reset signal, and a reset value signal;
a master stage operatively connected to the control stage and arranged to receive a data signal and the reset signal, wherein the master stage is arranged to generate an output value dependent on the control stage and the data signal; and
a slave stage operatively connected to the control stage and the master stage and arranged to receive the clock signal and the output value, wherein the slave stage is arranged to generate an output signal dependent on the clock signal and the output value,
wherein, upon assertion of the reset signal, the output signal is set to a value of the reset value signal asynchronous of the clock signal and dependent on the control stage.

2. The integrated circuit of claim 1, wherein the master stage and the slave stage are arranged to receive the clock signal, and wherein the slave stage receives an edge of the clock signal before the master stage receives the edge of the clock signal.

3. The integrated circuit of claim 1, wherein the control stage comprises:
a first inverter arranged to receive the clock signal;
a second inverter arranged to receive the reset signal;
a first logic gate operatively connected to the first inverter and the second inverter,
a second logic gate operatively connected to the first logic gate and arranged to receive the clock signal, wherein the second logic gate is adapted to generate a sample signal dependent on the first logic gate and the clock signal,
wherein the master stage is arranged to receive the sample signal.

4. The integrated circuit of claim 3, wherein the control stage further comprises a third inverter arranged to receive the reset signal, and wherein the third inverter is operatively connected to the master stage and the slave stage.

5. The integrated circuit of claim 3, wherein the control stage further comprises a fourth inverter arranged to receive the reset value signal, and wherein the fourth inverter is operatively connected to the master stage and the slave stage.

6. The integrated circuit of claim 1, wherein the master stage comprises:
a first inverter arranged to receive the data signal, wherein the first inverter generates a first data value;
a second inverter operatively connected to the first inverter, wherein the second inverter generates a second data value;
a first transistor arranged to receive the first data value from the first inverter;
a second transistor arranged to receive the second data value from the second inverter;
a master latch operatively connected to the first transistor and the second transistor, wherein the master latch is arranged to receive the first data value and the second data value dependent on the clock signal; and
a third inverter arranged to receive the first data value from the master latch, wherein the third inverter is operatively connected to the slave stage; and
a fourth inverter arranged to receive the second data value from the master latch, wherein the fourth inverter is operatively connected to the slave stage.

7. The integrated circuit of claim 6, wherein the master stage further comprises a first pass gate operatively connected to the fourth inverter and arranged to receive the reset signal and the reset value signal, and wherein the first pass gate resets the second data value to the value of the reset value signal dependent on the reset signal.

8. The integrated circuit of claim 6, wherein the slave stage comprises:
a third transistor arranged to receive the first data value;
a fourth transistor arranged to receive the second data value;
a slave latch operatively connected to the third transistor and the fourth transistor, wherein the slave latch is arranged to receive the first data value and the second data value dependent on the clock signal; and
a third inverter arranged to receive the first data value from the slave latch, wherein the third inverter is operatively connected to the slave stage; and
a fourth inverter arranged to receive the second data value from the slave latch, wherein the fourth inverter is operatively connected to the slave stage.

9. The integrated circuit of claim 8, wherein the slave stage further comprises a second pass gate operatively connected to the slave latch and arranged to receive the reset signal and the reset value signal, and wherein the second pass gate resets the first data value to the value of the reset value signal dependent on the reset signal.

10. A single edge-triggered flip-flop capable of being programmably reset asynchronous of a clock signal, comprising:
control means for receiving the clock signal and a reset signal;
master means for generating an output value dependent on the control means and a data signal;
slave means for generating an output signal dependent on the control means and the output value,
wherein, upon assertion of the reset signal, the output signal is set to a programmed value asynchronous of the clock signal and dependent on the control means.

11. The single edge-triggered flip-flop of claim 10, wherein the output signal is set to the programmed value dependent on a reset value signal inputted by the control means.

12. The integrated circuit of claim 10, wherein the master means and the slave means are arranged to receive the clock signal, and wherein the slave means receives an edge of the clock signal before the master means receives the edge of the clock signal

13. A method for performing a single edge-triggered flip-flop operation, comprising: inputting a data signal, a reset signal, and a reset value signal;
latching an output value on an edge of a clock signal dependent on the data signal;
generating an output signal dependent on the clock signal and the output value; and
upon assertion of the reset signal, setting the output signal to a value of the reset value signal asynchronous of the clock signal.
